(19) United States
(12) Patent Application Publication
(10) Pub. No.: US 2007/0030173 A1
(43) Pub. Date: Feb. 8, 2007

(54) Method and apparatus for high altitude environmental data collection

(75) Inventors: Emray R. Goossen, Albuquerque, NM (US); John A. Stokely, Albuquerque, NM (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/179,267

(22) Filed: Jul. 12, 2005

(51) Int. Cl. G01C 23/00

(52) U.S. Cl. 340/971

(57) ABSTRACT

A system consisting of a collection of aircraft equipped with specific chemical, radiological or particulate sensors as well as a data link radio and navigation sub system flying their normal routes. The position, sensor output and air data is periodically communicated to the ground via a data link radio and collected. The data is used to make maps or models of the spatial distribution of the sensed quantity for a particular time period. Dynamic behavior can be discerned by considering time consecutive models. Predictions can be made using this data alone, or in conjunction with other data, and can be refined by comparisons between the prediction and subsequent spatial distribution maps.

### BACKGROUND OF THE INVENTION

1 Field of the Invention (Technical Field)

The present invention relates to data collection, compiling and distribution and more particularly to air component sensor data collected aboard at least one aircraft matched with location data and sent to at least one receiving site for distribution to end users.

2 Background Art

Thematic maps and models, and the conditions they portray or predict, have historically been made using sensor platforms dedicated solely to these tasks. For example, in the realm of weather mapping and prediction, specialized aircraft, satellites, balloons and earthbound weather sensing stations all contribute to the generation of weather maps and to weather prediction. The situation is similar for thematic map and predictions generation where the sensed quantity is, for example, particulate, chemical, or radiological.

On any given day and at any given time, there are thousands of air transport aircraft in the air. Each of these aircraft is equipped with air data systems that measure temperature and pressure and compute such things as wind direction and speed. In addition, these aircraft come equipped with navigation systems sufficient to determine the aircraft position at a given point in time. Today, many air transport aircraft are equipped with data link capability, and this number of equipped aircraft is growing every day.

A system that collects from data link equipped aircraft, air data, position, altitude and time can be used to produce a data base that can be used in the mapping and prediction of weather and climate. The contents of this database can be used to populate a finite element weather analysis. The collection of such weather related data using existing aircraft sensors and the transmission to the ground has been taught by Bateman et al., in U.S. Pat. No. 6,043,756 and Gremmert et al., in U.S. Pat. No. 6,501,392. Batemen and Gremmert teach the use of datalink radios to downlink weather data from existing aircraft sensors. This information is used to make weather maps and predictions. Weather and predictions appropriate to an area are uplinked to aircraft flying in that area.

In the present invention, sensors specific to the detection of particulate, chemical, biological or radiological air constituents are placed aboard either commercial or military aircraft. The aircraft flight path is not chosen for sensor detection purposes, so as the aircraft is performing its normal duties. The data from these sensors, in addition to positional data, time and air data system outputs, are communicated to the ground to a collection system on a regular basis. The data can be used to create thematic maps comprising the distribution of the air constituents and, since the data is collected regularly, a dynamic picture of the movement of these constituents can be created.

Currently, air transport aircraft fly vector airways between their departure and arrival cities. These vector airways can be thought of as highways in the sky. This implies that only a relatively small portion of the earth's atmosphere is available to collect air data on. The populated land masses, such as western Europe, the east and west coasts of North America, and the pacific rim of Asia contain such a large number of vector airways as to eliminate this constraint. In addition, the concept of free flight, whereby an air transport aircraft can take the most direct available route, will increase the coverage available for air data collection. The present invention uses sensor packages to allow for the detection, mapping and modeling of chemical, particulate, biological and radiological phenomena.

### SUMMARY OF THE INVENTION (DISCLOSURE OF THE INVENTION)

The present invention comprises sensors specific to the detection of particulate, chemical, biological or radiological air constituents, placed aboard either commercial or military aircraft. As the aircraft fly in its normal course, the data from these sensors, in addition to positional data, are communicated to the ground to a collection system on a regular basis. The data can be used to create thematic maps on the distribution of the air constituents and, since the data is collected regularly, a dynamic picture of the movement of these constituents can be created.

A primary object of this invention is to use existing and future aircraft fleets to collect data on air components that are relevant to current or future problems and to produce spatial models or maps of the distribution of these components.

Another object of this invention is to periodically collect such data which permits the creation of a time sequence of such thematic maps.

Yet another object of the present invention is to provide time sequence models that can be used to make predictions or to refine predictions produced by other means.

A primary advantage of this invention is that it allows for the collection of data on the distribution of relevant air components at low cost, since the sensors are aboard aircraft that are flying their normal flight plans.

Another advantage is that there is nearly constant coverage as these aircraft are flying at all hours along the myriad of flight routes that crisscross the globe.

It is also an advantage that higher aircraft density corresponds to higher population density in that aircraft tend to group around large population centers. Thus greater spatial and temporal resolution can be achieved in the very regions that have the most to benefit from detailed timely thematic maps.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 shows the preferred embodiment of the invention.

### DESCRIPTION OF THE PREFERRED EMBODIMENTS (BEST MODES FOR CARRYING OUT THE INVENTION)

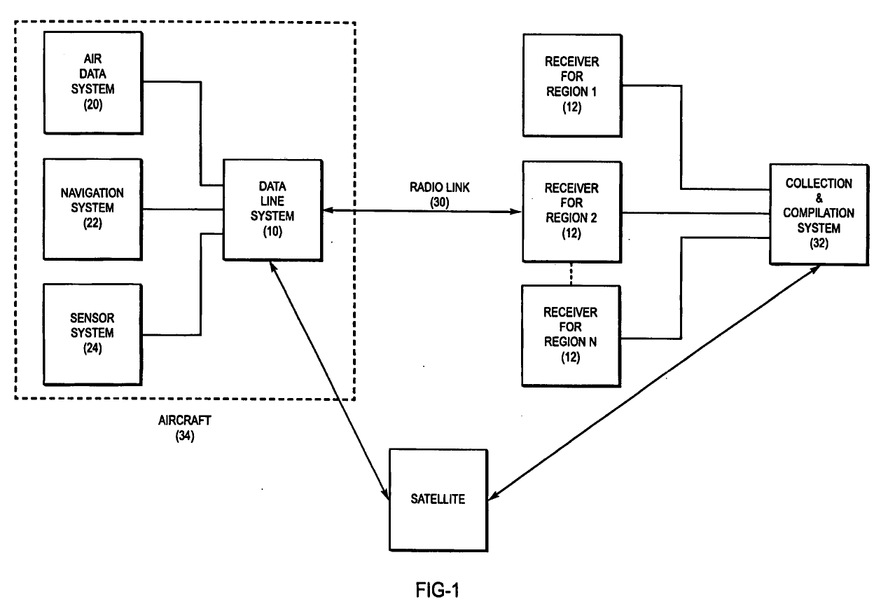

The present invention is a method and apparatus for obtaining air constituent sensor data from at least one aircraft, a means for compiling the data, a transmission apparatus for sending the compiled data along with time and location data to a receiving station and a means for obtaining the compiled data by users. Referring to FIG. 1, the airborne components of the invention include an air data system 22, navigation system 20, sensor system 24 and data link system 10.

Data link system 10 is responsible for aircraft radio communications with the regional receivers 12 and for directly or indirectly receiving data from the navigation 20, air data 22 and sensor 24 systems. All necessary formatting of the data in preparation for transmission is also done by data link system 10.

Air data system 20 can either provide raw data, such as static and impact pressure and total temperature, and the like, or may provide derived quantities such as altitude, wind speed and direction, and true or computed airspeed.

Navigation system 22 includes all necessary navigational sensors such as gyros, accelerometers, radar altimeters, GPS receivers, LORAN receivers as well as such computing hardware and software as is needed to compute at least one estimate of present location. A three dimensional location is assumed, such as latitude, longitude and altitude. Navigation system 22 may compute more than one position estimate based on navigational sensors and software used.

Sensor system 24 is collection of one or more devices that can measure the degree to which a sensed quantity is present at the particular aircraft position at a particular time. Sensors envisioned by this invention include, but are not limited to, chemical sensor for specific compounds or for classes of compounds, spectrographic sensors, sensors for particulate matter, sensors for specific biological species or for classes of biological species and radiological sensors sensitive to either subatomic particles or nuclear electromagnetic radiation. Sensor system 24 may report raw sensor output such as scintillation counts, or spectra or may report derived quantities from the raw sensor output.

Referring again to FIG. 1, the ground based systems include regional receivers 12 and a collection and compilation system 32. In this embodiment, the regional receiver 12 directly receives data from aircraft 34 in its region via a radio link 36. Another embodiment involves the use of a satellite, whereby the aircraft communicates with the satellite and the satellite communicates with a ground station radio link 36 between aircraft 34 and regional receiver 12 may be bi-directional, but as a minimum, the receiver 12 must be able to receive data, directly or indirectly, from passing aircraft 34. Each receiver 12 is capable of communicating with many aircraft.

Collection and compilation system 32 collects the data, the time and the aircraft position from all receivers 12 and creates one or more electronic files. Collection and compilation system 32 would consist of communication channels sufficient to handle the traffic from the regional receivers 12, sufficient computing power to create the needed electronic files and sufficient memory to store the electronic files. The various parts of the collection and compilation system 32 may be physically located together or may be located in different sites (virtual). The preferred embodiment for the electronic files is a database containing the data collected by the system, but the invention is not restricted to the type or format of file created. Collection and compilation system 32 is connected to receivers 12 via communication channels. The present invention is not restricted to the type or format of these communication channels. In the case of a virtual collection and compilation system, parts of this system may be physically located with one or more of the regional receivers. The collection and compilation system 32 need not log all available data, but may be designed so as to collect specific data for specific mapping or modeling application.

### INDUSTRIAL APPLICABILITY

The invention is further illustrated by the following non-limiting example.

As an example, consider a fleet of commercial aircraft equipped with sulfuric acid sensors. Again referring to FIG. 1, aircraft 34 are flying their normal routes over the North American continent. Aircraft 34 are fitted with chemical sensors 24, specifically for detecting sulfuric acid. Sensors 24, collect sulfuric acid concentrations and communicate them, via data link system 10, to the ground, comprising regional receivers 12 and a collection and compilation system 32, on a periodic basis, for example, every thirty seconds. This data is collected into a database and used to make a model, or map, of sulfuric acid concentrations over the continent for a time, for example between noon and one o'clock Pacific Standard Time. A similar model or map can be made for the time between one and two o'clock. These two maps can be compared and dynamic and stationary features observed. For example, it may be that a stationary high concentration area may exist downwind of a large coal burning power plant or it may be that the concentration of the sulfuric acid changes significantly with wind velocity around this same power plant. Since the winds aloft are measured by the air data system on the aircraft at the time of sensor measurement, and since models of wind direction and speed are produced regularly by various weather services, a prediction of where the sulfuric acid concentrations will be in the future can be estimated. In addition, since a new model of the sulfuric acid concentration distribution is made periodically, the predictions can be refined against the more recently made models.

Similar types of models could be made for chlorinated hydrocarbons, or beta emitting particles. Of particular interest is the detection of weapons of mass destruction, the sensors for which are undergoing a rapid development at this time.

What is claimed is:

1. A system for collecting air constituent information from a sensor system disposed on at least one aircraft, the system comprising:
said at least one aircraft comprising an air data system, a navigation system, a data link system and the sensor system, the sensor system comprising at least one sensor;
a means for collecting and compiling sensor data from said sensor system, air data system data and navigation system data; and
a transmitter for transmitting the compiled data to at least one receiving station.

2. The system of claim 1 wherein said at least one sensor comprises of a member from the group consisting of a chemical sensor, a particulate sensor and a radiological sensor.

3. The system of claim 1 wherein said navigation system comprises aircraft position data and time data.

4. The system of claim 1 further comprising a means for creating a thematic map from said compiled data.

5. The system of claim 5 wherein said means for creating a thematic map comprises a means for creating a thematic map for a predefined period of time.

6. The system of claim 1 further comprising a means for creating a thematic map from said transmitted data from each receiving station from said at least one receiving station.

7. The system of claim 7 wherein the means for creating a thematic map comprises a means for creating a thematic map over a predefined period of time.

8. A method for collecting air constituent information collected from sensor system disposed on at least one aircraft comprising:
a) providing at least one sensor comprising the sensor system on the at least one aircraft;
b) collecting air constituent data from the sensor system;
c) compiling the collected air constituent data with data from a navigation system and data from an air data system, the navigation system and the air data system on board the at least one aircraft; and
d) transmitting the compiled data to at least one receiving station.

9. The method of claim 9 wherein the at least one sensor comprises a member from the group consisting of a chemical sensor, a particulate sensor and a radiological sensor.

10. The method of claim 9 wherein the navigation system comprises aircraft position data and time data.

11. The method of claim 9 further comprising the step of creating a thematic map from the compiled data.

12. The method of claim 13 wherein the step of creating a thematic map comprises creating a thematic map over a predefined period of time.

13. The method of claim 9 further comprising the step of predicting an air constituent quantity from the compiled data.

14. The method of claim 9 further comprising the step of creating a thematic map from the transmitted data from each receiving station from the at least one receiving station.

15. The method of claim 16 wherein the step of creating a thematic map comprises creating the thematic map over a predefined period of time.
